(19) United States
(12) Patent Application Publication
(10) Pub. No.: US 2024/0153166 A1
(43) Pub. Date: May 9, 2024

(54) SYSTEMS AND METHODS FOR POSITRON EMISSION TOMOGRAPHY IMAGING

(71) Applicant: SHANGHAI UNITED IMAGING HEALTHCARE CO., LTD., Shanghai (CN)

(72) Inventors: Liuchun HE, Shanghai (CN); Hancong XU, Shanghai (CN); Qing YE, Shanghai (CN); Tao FENG, Houston, TX (US)

(73) Assignee: SHANGHAI UNITED IMAGING HEALTHCARE CO., LTD., Shanghai (CN)

(21) Appl. No.: 18/415,573

(22) Filed: Jan. 17, 2024

Related U.S. Application Data
(63) Continuation of application No. PCT/CN2022/141631, filed on Dec. 23, 2022.

(30) Foreign Application Priority Data
Dec. 24, 2021 (CN) 202111607762.4
May 6, 2022 (CN) 202210487528.0

(51) Int. Cl. G06T 11/00

(52) U.S. Cl. CPC G06T 11/008; G06T 11/005

(57) ABSTRACT

A method and a system for positron emission tomography (PET) imaging may be provided. Scan data of an object in a first time period of a PET scan of the object may be obtained. A reference image of the object may be also obtained. The reference image may be reconstructed based on reference scan data in a second time period of the PET scan. A target image of the object in the first time period may be generated using an image reconstruction model based on the scan data in the first time period and the reference image of the object.

### CROSS-REFERENCE TO RELATED APPLICATIONS

This application is a continuation of International Application No. PCT/CN2022/141631, filed on Dec. 23, 2022, which claims priority to Chinese Patent Application No. 202210487528.0, filed on May 6, 2022, and Chinese Patent Application No. 202111607762.4, filed on Dec. 24, 2021, the entire contents of each of which are hereby incorporated by reference.

### TECHNICAL FIELD

The present disclosure relates to medical imaging, and more specifically relates to systems and methods for positron emission tomography (PET) imaging.

### BACKGROUND

PET imaging has been widely used in clinical examination and disease diagnosis in recent years. Efficiency and accuracy of PET imaging are vital for clinical examination and disease diagnosis. Thus, it is desired to provide systems and methods for PET imaging with improved efficiency and accuracy.

### SUMMARY

According to an aspect of the present disclosure, a system for positron emission tomography (PET) imaging may be provided. The system may include at least one storage device including a set of instructions and at least one processor. The at least one processor may be configured to communicate with the at least one storage device. When executing the set of instructions, the at least one processor may be configured to direct the system to perform one or more of the following operations. The system may obtain scan data of an object in a first time period of a PET scan of the object. The system may also obtain a reference image of the object. The reference image may be reconstructed based on reference scan data in a second time period of the PET scan. The system may further generate a target image of the object in the first time period using an image reconstruction model based on the scan data in the first time period and the reference image of the object.

In some embodiments, the second time period may include at least a portion of the first time period.

In some embodiments, the scan data of the object may be in form of histo-image.

In some embodiments, to generate a target image of the object in the first time period using an image reconstruction model based on the scan data in the first time period and the reference image of the object, the system may obtain corrected scan data by performing a correction on the scan data in the first time period. The correction may include at least one of an attenuation correction, a random correction, or a normalization correction. The system may further generate the target image of the object using the image reconstruction model based on the corrected scan data and the reference image of the object.

In some embodiments, the reference scan data may be obtained by performing a scatter correction on scan data in the second time period of the object.

In some embodiments, the image reconstruction model may be generated according to the following training process. One or more first training samples may be obtained. Each first training sample may include first sample scan data of a first sample object in a sample first time period, a sample reference image of the first sample object, and a sample target image of the first sample object in the sample first time period. The sample reference image may be reconstructed based on sample reference scan data obtained by performing a scatter correction on sample scan data of the first sample object in a sample second time period. The image reconstruction model may be generated by training a first preliminary model using the one or more first training samples.

In some embodiments, the scan data in the second time period may be in form of histo-image, and to perform the scatter correction, the system may obtain an attenuation map of the object in the second time period. The system may further determine an activity map of a tracer for the PET scan using an activity map determination model based on the scan data in the second time period and the attenuation map of the object. The system may further perform the scatter correction on the scan data in the second time period of the object based on the activity map.

In some embodiments, to perform the scatter correction on the scan data in the second time period of the object based on the activity map, the system may determine a scatter estimation of the tracer based on the attenuation map and the activity map of the tracer. The system may further perform the scatter correction on the scan data in the second time period of the object based on the scatter estimation.

In some embodiments, the activity map determination mode may be generated according to a training process. One or more second training samples may be obtained. Each second training sample may include second sample scan data of a second sample object, a sample attenuation map of the second sample object, and a reference activity map of a tracer. The second sample scan data may be in form of histo-image. The activity map determination mode may be generated by training a second preliminary model using the one or more second training samples.

In some embodiments, to perform the scatter correction, the system may determine a plurality of energy ranges of coincidence events generated in the second time period based on the scan data in the second time period. The system may also determine scatter estimation of a tracer for the PET scan in the second time period based on the plurality of energy ranges of coincidence events. The system may further perform the scatter correction on the scan data in the second time period of the object based on the scatter estimation.

In some embodiments, to determine scatter estimation of a tracer for the PET scan in the second time period based on the plurality of energy ranges of coincidence events, the system may obtain a count of coincidence events corresponding to each of one or more reference energy ranges among the plurality of energy ranges of coincidence events based on the scan data in the second time period. Energy values in at least one of the one or more reference energy ranges may be smaller than an energy value corresponding to a true coincidence event. The system may further determine the scatter estimation in the second time period based on the plurality of energy ranges and the count of coincidence events corresponding to each of the one or more reference energy ranges.

In some embodiments, the one or more reference energy ranges may include a first energy range and a second energy range in the second time period. To determine a plurality of energy ranges of coincidence events based on the scan data in the second time period, the system may obtain a minimum energy value and a maximum energy value based on a coincidence energy window for determining coincidence events of the PET scan. The system may also determine a first energy value and a second energy value. The first energy value may be smaller than the energy value corresponding to the true coincidence event and the second energy value may be greater than the energy value corresponding to the true coincidence event. The system may further determine the first energy range and the second energy range based on the minimum energy value, the maximum energy value, the first energy value, and the second energy value.

According to another aspect of the present disclosure, a system for positron emission tomography (PET) imaging may be provided. The system may include at least one storage device including a set of instructions and at least one processor. The at least one processor may be configured to communicate with the at least one storage device. When executing the set of instructions, the at least one processor may be configured to direct the system to perform one or more of the following operations. The system may obtain scan data of an object of a PET scan of the object. The scan data may be in form of histo-image. The system may also obtain an attenuation map of the object. The system may further determine an activity map of a tracer for the PET scan using an activity map determination model based on the scan data and the attenuation map of the object.

According to yet another aspect of the present disclosure, a system for positron emission tomography (PET) imaging may be provided. The system may include at least one storage device including a set of instructions and at least one processor. The at least one processor may be configured to communicate with the at least one storage device. When executing the set of instructions, the at least one processor may be configured to direct the system to perform one or more of the following operations. The system may obtain scan data of an object of a PET scan of the object. The system may also determine a plurality of energy ranges of coincidence events generated in the PET scan based on the scan data. The system may determine scatter estimation of a tracer for the PET scan based on the plurality of energy ranges of coincidence events.

According to yet another aspect of the present disclosure, a method for positron emission tomography (PET) imaging may be provided. The method may include obtaining scan data of an object in a first time period of a PET scan of the object. The method may also include obtaining a reference image of the object. The reference image may be reconstructed based on reference scan data in a second time period of the PET scan. The method may further include generating a target image of the object in the first time period using an image reconstruction model based on the scan data in the first time period and the reference image of the object.

According to yet another aspect of the present disclosure, a method for positron emission tomography (PET) imaging may be provided. The method may include obtaining scan data of an object of a PET scan of the object. The scan data may be in form of histo-image. The method may also include obtaining an attenuation map of the object. The method may further include determining an activity map of a tracer for the PET scan using an activity map determination model based on the scan data and the attenuation map of the object.

According to yet another aspect of the present disclosure, a method for positron emission tomography (PET) imaging may be provided. The method may include obtaining scan data of an object of a PET scan of the object. The method may also include determine a plurality of energy ranges of coincidence events generated in the PET scan based on the scan data. The method may further include determining scatter estimation of a tracer for the PET scan based on the plurality of energy ranges of coincidence events.

According to yet another aspect of the present disclosure, a system for positron emission tomography (PET) imaging may be provided. A system may include an acquisition module and a generation module. The acquisition module may be configured to obtain scan data of an object in a first time period of a PET scan of the object and a reference image of the object. The reference image may be reconstructed based on reference scan data in a second time period of the PET scan. The generation module may be configured to generate a target image of the object in the first time period using an image reconstruction model based on the scan data in the first time period and the reference image of the object.

According to yet another aspect of the present disclosure, a system for positron emission tomography (PET) imaging may be provided. The system may include an acquisition module and a determination module. The acquisition module may be configured to obtain scan data of an object of a PET scan of the object and an attenuation map of the object. The scan data may be in form of histo-image. The determination module may be configured to determine an activity map of a tracer for the PET scan using an activity map determination model based on the scan data and the attenuation map of the object.

According to yet another aspect of the present disclosure, a system for positron emission tomography (PET) imaging may be provided. The system may include an acquisition module and a determination module. The acquisition module may be configured to obtain scan data of an object of a PET scan of the object. The determination module may be configured to determine a plurality of energy ranges of coincidence events generated in the PET scan based on the scan data, and determine scatter estimation of a tracer for the PET scan based on the plurality of energy ranges of coincidence events.

According to yet another aspect of the present disclosure, a non-transitory computer readable medium may be provided. The non-transitory computer readable medium may comprise at least one set of instructions for positron emission tomography (PET) imaging. When executed by one or more processors of a computing device, the at least one set of instructions causes the computing device to perform a method. The method may include obtaining scan data of an object in a first time period of a PET scan of the object. The method may also include obtaining a reference image of the object. The reference image may be reconstructed based on reference scan data in a second time period of the PET scan. The method may further include generating a target image of the object in the first time period using an image reconstruction model based on the scan data in the first time period and the reference image of the object.

According to yet another aspect of the present disclosure, a non-transitory computer readable medium may be provided. The non-transitory computer readable medium may comprise at least one set of instructions for positron emission tomography (PET) imaging. When executed by one or more processors of a computing device, the at least one set of instructions causes the computing device to perform a method. The method may include obtaining scan data of an object of a PET scan of the object. The scan data may be in form of histo-image. The method may also include obtaining an attenuation map of the object. The method may further include determining an activity map of a tracer for the PET scan using an activity map determination model based on the scan data and the attenuation map of the object.

According to yet another aspect of the present disclosure, a non-transitory computer readable medium may be provided. The non-transitory computer readable medium may comprise at least one set of instructions for positron emission tomography (PET) imaging. When executed by one or more processors of a computing device, the at least one set of instructions causes the computing device to perform a method. The method may include obtaining scan data of an object of a PET scan of the object. The method may also include determine a plurality of energy ranges of coincidence events generated in the PET scan based on the scan data. The method may further include determining scatter estimation of a tracer for the PET scan based on the plurality of energy ranges of coincidence events.

According to yet another aspect of the present disclosure, a device for positron emission tomography (PET) imaging may be provided. The device may include at least one processor and at least one storage device for storing a set of instructions. When the set of instructions may be executed by the at least one processor, the device performs the methods for positron emission tomography (PET) imaging.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A is a schematic diagram illustrating an exemplary PET system according to some embodiments of the present disclosure;

FIG. 1B is a schematic diagram illustrating an exemplary detector according to some embodiments of the present disclosure;

FIG. 2A is a schematic diagram illustrating an exemplary electronic device on which the processing device may be implemented according to some embodiments of the present disclosure;

FIG. 2B is a block diagram illustrating exemplary processing device according to some embodiments of the present disclosure;

FIG. 3 is a flowchart illustrating an exemplary process for generating a target image of an object according to some embodiments of the present disclosure;

FIG. 4 is a flowchart illustrating an exemplary process for scatter correction according to some embodiments of the present disclosure;

FIG. 5 is a flowchart illustrating another exemplary process for scatter correction according to some embodiments of the present disclosure;

FIG. 6 is a schematic diagram illustrating an exemplary scatter coincidence event according to some embodiments of the present disclosure;

FIG. 7 is a schematic diagram illustrating an exemplary 1D energy spectrum 700 of a PET scan according to some embodiments of the present disclosure; and

FIG. 8 is a schematic diagram illustrating an exemplary 2D energy spectrum 800 of a PET scan according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, sections or assembly of different levels in ascending order. However, the terms may be displaced by another expression if they achieve the same purpose.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that when a unit, engine, module, or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items. The term “pixel” and “voxel” in the present disclosure are used interchangeably to refer to an element of an image. An anatomical structure shown in an image of an object (e.g., a patient) may correspond to an actual anatomical structure existing in or on the object's body.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

Provided herein are systems and components for non-invasive imaging and/or treatment, such as for disease diagnosis, treatment, or research purposes. In some embodiments, the systems may include a single modality system and/or a multi-modality system. The single modality system may include, for example, a positron emission tomography (PET) system. The multi-modality system may include, for example, a positron emission tomography-magnetic resonance imaging (PET-MRI) system, a positron emission tomography-computed tomography (PET-CT) system, etc. For illustration purposes, the present disclosure describes systems and methods for PET.

Dynamic PET imaging can provide a set of images over a dynamic scan time and dynamic PET data can also provide rich information related to physiological parameters (e.g., perfusion pressure) that indicate the functional status of the imaged tissue(s) or organ(s). Conventionally, each image during the dynamic PET imaging is generated by performing one or more iterations on scan data in a time period, which is computationally intensive and inefficient. The efficiency of PET image reconstruction may be improved using a deep learning technique. However, during the PET image reconstruction process using the deep learning technique, for each image, it is still necessary to use traditional scatter correction to obtain corrected scan data for generating the image, so that the image is reconstructed based on the corrected scan data, which has limited efficiency.

Compton scatter is a major factor in image quality and quantitation degradation for PET that should be accounted for high quality image reconstruction. Therefore, a scatter correction of the scan data is vital for PET image reconstruction. Some conventional scatter correction approaches usually involve multiple iterations for obtaining an accurate activity map. For example, an initial activity map of a tracer for the PET scan are reconstructed using the original scan data (i.e., the scan data on which no scatter correction has been performed), and an initial scatter estimate is determined based on the initial activity map and an attenuation map. An updated activity map is then reconstructed based on the initial scatter estimate. This is repeated one or more times until a preset condition is satisfied to obtain an accurate activity map. Then, the scatter correction may be performed on the scan data based on the accurate activity map and an attenuation map using a scatter correction algorithm such as a single scatter simulation (SSS) algorithm, a Monte-Carlo simulation (MCS) algorithm, a double scatter simulation (DSS) algorithm, etc. Therefore, the conventional scatter correction approaches are inefficient.

Some conventional scatter correction approaches based on energy information of raw data (e.g., U.S. Patent Applications including US20210059617(A1), US20210059629(A1), WO2019149621 (A1)) involve correction of raw data, which is highly efficient but requires high statistics. These approaches often need to do scatter correction based on compressed lines of response (LORs), which are combined from dozens or hundreds of raw LORs, to achieve sufficient statistics. However, when performing time-of-flight (TOF) reconstruction, if the PET scanner has a high temporal resolution, coincidence events will be dispersed across dozens of TOF bins, resulting in sharp reduce of the energy spectrum statistics in different TOF bins. In order to solve the problem of insufficient statistics, in US20210059617(A1), a specific filter is added to the energy spectrum to reduce noise, and in WO2019149621 (A1), a low-noise scattering estimation is obtained by forward-projecting scattering information from an image domain to an energy domain, but these approaches have not yet been applied in clinical use. In addition, US20210030387(A1) discloses that a relatively accurate activity map is obtained using a narrow coincidence energy window filtering, and then final scatter estimation is obtained based on the activity map using scatter correction algorithms. However, US20210030387 (A1) only utilizes the narrower coincidence energy window with less scatter content, and uses TOF reconstruction to compensate for the image quality, which cannot obtain accurate scatter corrected activity map, thereby having a limited accuracy.

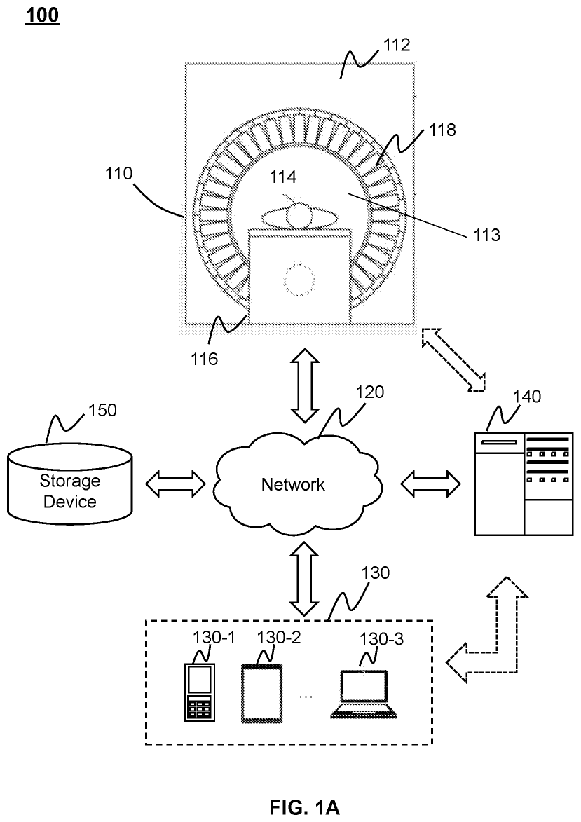

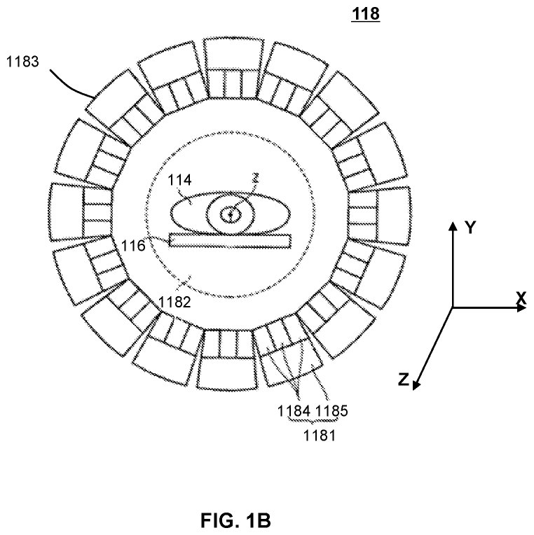

FIG. 1A is a schematic diagram illustrating an exemplary PET system according to some embodiments of the present disclosure. PET imaging is based on coincidence events corresponding to detected photons arising from positron-electron annihilation.

The PET system 100 may include a PET scanner 110, a network 120, a terminal 130, a processing device 140, and a storage device 150. The components in the PET system 100 may be connected in one or more of various manners. Merely by way of example, the PET scanner 110 may be connected to the processing device 140 through the network 120. As another example, the PET scanner 110 may be connected to the processing device 140 directly (shown as the bi-directional arrow in dotted line linking the PET scanner 110 and the processing device 140). As another example, the processing device 140 may be connected to the storage device 150 through the network 120 or directly.

The PET scanner 110 may include a gantry 112, a table 116, and a detector 118. An object 114 injected with a substance (e.g., generally necessary for the metabolism of biological life, such as glucose, protein, nucleic acids, fatty acids, etc.) labeled with a tracer for the imaging purposes may be placed on the table 116. The detector 118 may be mounted on the gantry 112. The gantry 112 may form a detection channel 113.

The tracer refers to a radioactive substance (e.g., radionuclides such as 18F, 11C, etc.) that decays and emits positrons. The object 114 may be biological or non-biological. Merely by way of example, the object 114 may include a patient, a man-made object, etc. As another example, the object 114 may include a specific portion, organ, and/or tissue of the patient. For example, the object 114 may include the head, the brain, the neck, the body, a shoulder, an arm, the thorax, the heart, the stomach, a blood vessel, a soft tissue, a knee, a foot, or the like, of a patient, or any combination thereof.

In the present disclosure, the X axis, the Y axis, and the Z axis shown in FIG. 1B may form an orthogonal coordinate system. The X axis and the Z axis shown in FIG. 1B may be horizontal, and the Y axis may be vertical. As illustrated, the positive X direction along the X axis may be from the left side to the right side of the PET scanner 110 seen from the direction facing the front of the PET scanner 110; the positive Y direction along the Y axis shown in FIG. 1B may be from the lower part to the upper part of the PET scanner 110; the positive Z direction along the Z axis shown in FIG. 1B may refer to a direction in which the object is moved out of the detection channel 113 (or referred to as a bore) of the PET scanner 110.

As shown in FIG. 1B, the detector 118 may include a plurality of detector rings (e.g., a detector ring 1183) arranged along the Z direction (perpendicular to the paper as shown in FIG. 1B). The plurality of detector rings may be located around the detection channel. A detector ring may include a plurality of detector units (e.g., a detector unit 1181) arranged along the circumference of the detector ring.

The detector 118 may form a bore to accommodate the table 116. There may be a field of view (FOV) 1182 in the bore. During a scan process, the object 114 along with the table 116 may be moved into the bore to position a region of interest (ROI) of the object 114 in the FOV 1182.

As shown in FIG. 1B, a detector unit 1181 may include a scintillator 1184 and a photodetector 1185. The photodetector 1185 may be operably coupled to the scintillator 1184. In some embodiments, the scintillator 1184 may include an array of scintillation crystals.

In some embodiments, positrons emitted from the radiation may travel through the object 114 until they encounter electrons. When a positron and an electron meet, annihilation event may occur. The electron-positron annihilation may simultaneously generate two photons (e.g., 511-kiloelectron volt (keV) gamma photons) traveling in opposite directions along a line. The two photons may be detected by a pair of detector units. A coincidence event may be recorded when a pair of photons generated by the electron-positron annihilation are detected within a coincidence time window (e.g., within 6 to 12 nanoseconds).

Each of the two photons generated by an electron-positron annihilation may strike the scintillator 1184 to produce a burst of fluorescent light. The fluorescence may transmit from the scintillator 1184 to the photodetector 1185. The fluorescence may be converted to an electrical signal (e.g., an electrical pulse) by the photodetector 1185. The electrical signal may be transmitted to other components of the PET system 100, such as the processing device 140, to be determined as a coincidence event. A straight line connecting the two detector units that detect the coincidence event may be referred to as an original line of response (LOR).

In some embodiments, the detector unit 1181 may further include a light guide (not shown in FIG. 1B) configured to provide a light path to the photodetector 1185. In some embodiments, a front-end circuit board (not shown in FIG. 1B) may be coupled to the photodetector 1185 to process electrical signals and/or transmit electrical signals to other components (e.g., the processing device 140) of the PET system 100.

The network 120 may facilitate exchange of information and/or data. In some embodiments, one or more components (e.g., the imaging device 110, the terminal device 130, the processing device 140, the storage device 150) of the PET system 100 may send information and/or data to another component(s) of the PET system 100 via the network 120. For example, the processing device 140 may obtain, via the network 120, scan data relating to the object 118 or a portion thereof from the imaging device 110. In some embodiments, the network 120 may be any type of wired or wireless network, or a combination thereof.

The terminal device 130 may include a mobile device 130-1, a tablet computer 130-2, a laptop computer 130-3, or the like, or any combination thereof. In some embodiments, the terminal device 130 may remotely operate the imaging device 110. In some embodiments, the terminal device 130 may operate the imaging device 110 via a wireless connection. In some embodiments, the terminal device 130 may receive information and/or instructions inputted by a user, and send the received information and/or instructions to the imaging device 110 or the processing device 140 via the network 120. In some embodiments, the terminal device 130 may receive data and/or information from the processing device 140. In some embodiments, the terminal device 130 may be part of the processing device 140. In some embodiments, the terminal device 130 may be omitted.

In some embodiments, the processing device 140 may process data obtained from the imaging device 110, the terminal device 130, the storage device 150, or other components of the imaging system 100. For example, the processing device 140 may obtain scan data (e.g., PET data) of an object (e.g., a human body) in a first time period from the imaging device 110 or the storage device 150. The processing device 140 may also obtain a reference image of the object. The reference image may be reconstructed based on reference scan data in a second time period greater than the first time period of the PET scan. Further, the processing device 140 may determine a target image (e.g., a PET image) of the object in the first time period using an image reconstruction model based on the scan data in the first time period and the reference image of the object. As another example, the processing device 140 may perform a scatter correction on scan data of an object.

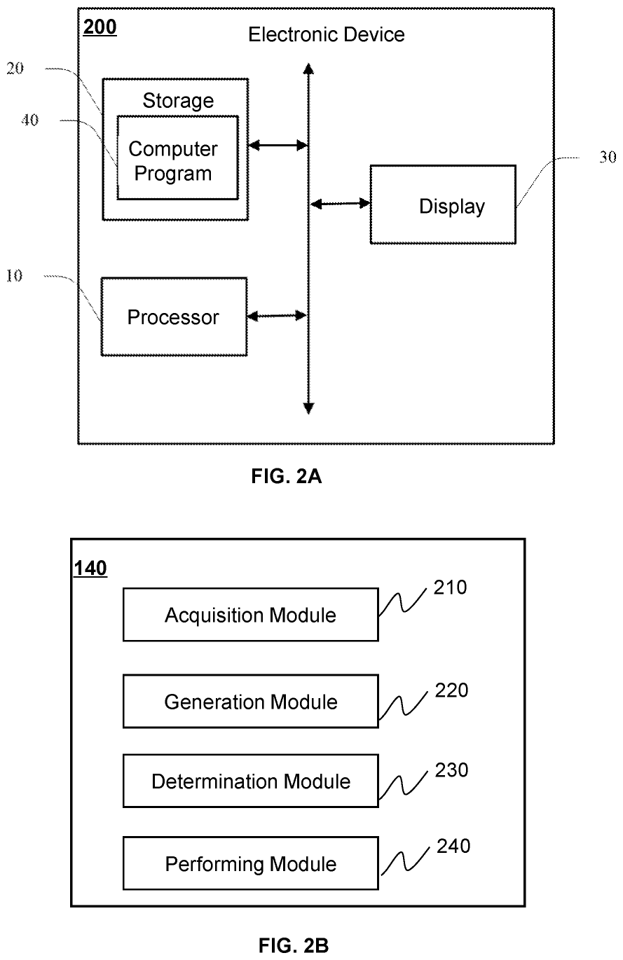

In some embodiments, the processing device 140 (e.g., one or more modules illustrated in FIG. 2B) may execute instructions and may accordingly be directed to perform one or more processes (e.g., process 300, 400, and 500) described in the present disclosure. For example, each of the one or more processes may be stored in a storage device (e.g., the storage device 150) as a form of instructions, and invoked and/or executed by the processing device 140.

In some embodiments, the processing device 140 may be a single server or a server group. In some embodiments, the processing device 140 may be local to or remote from the imaging system 100. Merely for illustration, only one processing device 140 is described in the imaging system 100. However, it should be noted that the imaging system 100 in the present disclosure may also include multiple processing devices. Thus operations and/or method steps that are performed by one processing device 140 as described in the present disclosure may also be jointly or separately performed by the multiple processing devices. For example, if in the present disclosure the processing device 140 of the imaging system 100 executes both process A and process B, it should be understood that the process A and the process B may also be performed by two or more different processing devices jointly or separately in the imaging system 100 (e.g., a first processing device executes process A and a second processing device executes process B, or the first and second processing devices jointly execute processes A and B).

The storage device 150 may store data, instructions, and/or any other information. In some embodiments, the storage device 150 may store data obtained from the processing device 140, the terminal 130, and/or the imaging device 110. For example, the storage device 150 may store scan data collected by the imaging device 110. As another example, the storage device 150 may store the target image of the object. In some embodiments, the storage device 150 may store data and/or instructions that the processing device 140 may execute or use to perform exemplary methods described in the present disclosure. In some embodiments, the storage device 150 may be connected to the network 120 to communicate with one or more components (e.g., the imaging device 110, the terminal device 130, the processing device 140) of the PET system 100. One or more components of the PET system 100 may access the data or instructions stored in the storage device 150 via the network 120. In some embodiments, the storage device 150 may be part of the processing device 140.

It should be noted that the above description of the PET system 100 is merely provided for the purposes of illustration, and not intended to limit the scope of the present disclosure. For persons having ordinary skills in the art, multiple variations and modifications may be made under the teachings of the present disclosure. For example, the PET system 100 may include one or more additional components and/or one or more components of the PET system 100 described above may be omitted. Additionally or alternatively, two or more components of the PET system 100 may be integrated into a single component. A component of the PET system 100 may be implemented on two or more sub-components.

FIG. 2A is a schematic diagram illustrating an exemplary electronic device on which the processing device may be implemented according to some embodiments of the present disclosure. As shown in FIG. 2A, the electronic device 200 may be a computing device such as a control device of a medical imaging system (e.g., the PET system 100), a mobile terminal, a desktop computer, a notebook, a palmtop computer, or a server, etc. The electronic device 200 may include a processor 10, a storage 20, and a display 30.

In some embodiments, the storage 20 may be an internal storage unit of the electronic device 200, such as a hard disk or a memory of the electronic device 200 200. In some embodiments, the storage 20 may also be an external storage device of the electronic device 200, such as a plug-in hard disk equipped on the electronic device 200, a smart memory card (SMC), a secure digital (SD) card, a flash card, etc. Further, the storage 20 may also include both an internal storage unit of the electronic device 200 and an external storage device. The storage 20 may be used to store application software and various data installed in the electronic device 200, such as program codes installed in the electronic device 200. The storage 20 may also be used to temporarily store data that has been output or will be output. In some embodiments, a computer program 40 may be stored in the storage 20, and the computer program 40 may be executed by the processor 10, so as to realize the methods of the present disclosure.

The processor 10 may be a central processing unit (CPU), a microprocessor, or other data processing chip for running the program code stored in storage 20 or processing data.

In some embodiments, the display 30 may be an LED display, a liquid crystal display, a touch-sensitive liquid crystal display, an organic light-emitting diode (OLED) touch device, or the like. The display 30 may be used for displaying information on the electronic device 200 and for displaying a visualized user interface. The processor 10, storage 20, and display 30 of the electronic device 200 may communicate with each other through a system bus.

It should be noted that the above description of the electronic device 200 200 is merely provided for the purposes of illustration, and not intended to limit the scope of the present disclosure. For persons having ordinary skills in the art, multiple variations and modifications may be made under the teachings of the present disclosure. For example, the electronic device 200 200 may include one or more additional components and/or one or more components of the electronic device 200 200 described above may be omitted. Additionally or alternatively, two or more components of the electronic device 200 200 may be integrated into a single component. A component of the P electronic device 200 200 may be implemented on two or more sub-components.

FIG. 2B is a block diagram illustrating exemplary processing device 140 according to some embodiments of the present disclosure.

As shown in FIG. 2B, the processing device 140 may include an acquisition module 210, a generation module 220, a determination module 230, and a performing module 240.

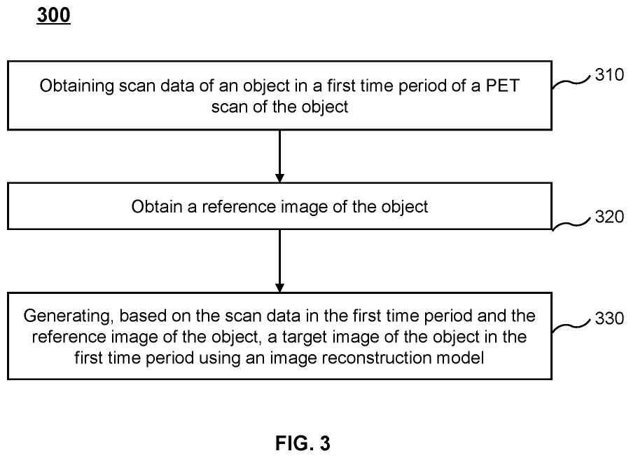

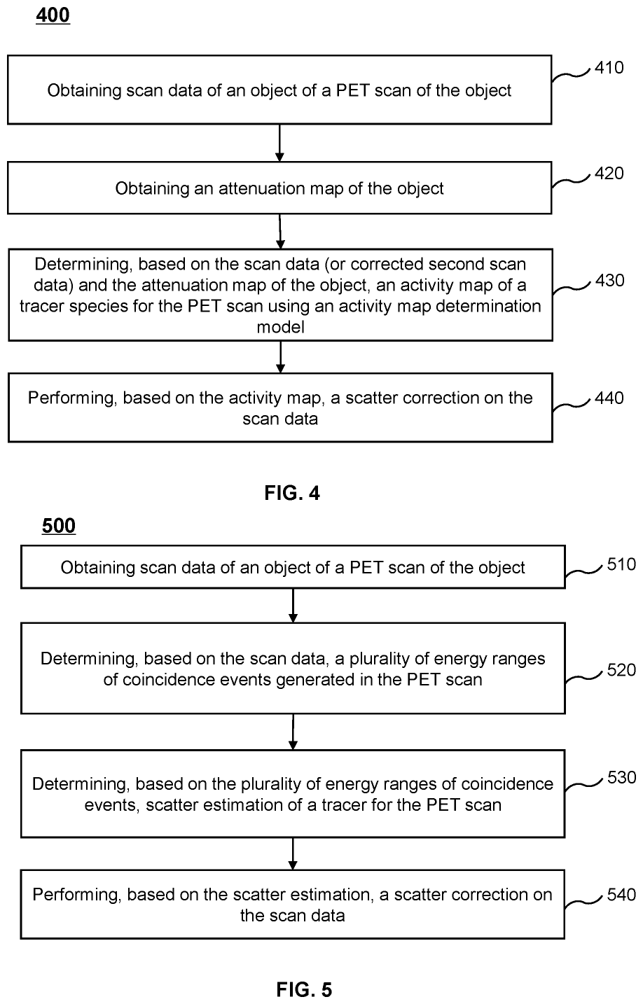

The acquisition module 210 may be configured to obtain information relating to the PET system 100. For example, the acquisition module 210 may be configured to obtain scan data of an object. More descriptions regarding the obtaining of the scan data may be found elsewhere in the present disclosure. See, e.g., operation 310 in FIG. 3, operation 410 in FIG. 4, operation 510 in FIG. 5, and relevant descriptions thereof. As another example, the acquisition module 210 may be configured to obtain a reference image of the object. More descriptions regarding the obtaining of the reference image of the object may be found elsewhere in the present disclosure. See, e.g., operation 320 in FIG. 3, and relevant descriptions thereof. As still another example, the acquisition module 210 may be configured to obtain an attenuation map of the object. More descriptions regarding the obtaining of the attenuation map of the object may be found elsewhere in the present disclosure. See, e.g., operation 420 in FIG. 4, and relevant descriptions thereof.

The generation module 220 may be configured to generate a target image of the object in the first time period using an image reconstruction model based on the scan data in the first time period and the reference image of the object. More descriptions regarding the generation of the target image of the object in the first time period may be found elsewhere in the present disclosure. See, e.g., operation 330 in FIG. 3, and relevant descriptions thereof.

The determination module 230 may be configured to determine an activity map of a tracer for the PET scan using an activity map determination model based on the scan data (or corrected scan data) and the attenuation map of the object. More descriptions regarding the determination of the activity map of a tracer for the PET scan using the activity map determination model may be found elsewhere in the present disclosure. See, e.g., operation 430 in FIG. 4, and relevant descriptions thereof.

In some embodiments, the determination module 230 may be also configured to determine a plurality of energy ranges of coincidence events generated in the PET scan based on the scan data, and determine a scatter estimation (also referred to as first scatter estimation) of a tracer for the PET scan based on the plurality of energy ranges of coincidence events. More descriptions regarding the determination of the plurality of energy ranges of coincidence events and the scatter estimation of the tracer for the PET scan may be found elsewhere in the present disclosure. See, e.g., operations 520 and 530 in FIG. 5, and relevant descriptions thereof.

The performing module 240 may be configured to perform a scatter correction on the scan data. For example, the performing module 240 may be configured to perform a scatter correction on the scan data based on the activity map. More descriptions regarding the performing the scatter correction on the scan data based on the activity map may be found elsewhere in the present disclosure. See, e.g., operation 440 in FIG. 4, and relevant descriptions thereof. As another example, the performing module 240 may be configured to perform a scatter correction on the scan data based on the scatter estimation. More descriptions regarding the performing the scatter correction on the scan data based on the scatter estimation may be found elsewhere in the present disclosure. See, e.g., operation 540 in FIG. 5, and relevant descriptions thereof.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, any one of the modules may be divided into two or more units. For instance, the acquisition module 210 may be divided into two units configured to acquire different data. In some embodiments, the processing device 140 may include one or more additional modules, such as a storage module (not shown) for storing data.

FIG. 3 is a flowchart illustrating an exemplary process for generating a target image of an object according to some embodiments of the present disclosure.

As used herein, the subject may include a biological subject and/or a non-biological subject. For example, the subject may be a human being, an animal, or a portion thereof. As another example, the subject may be a phantom that simulates a human cardiac region. In some embodiments, the subject may be a patient (or a portion thereof). The object may include a specific portion, organ, and/or tissue of the patient. For example, the object may include the head, the brain, the neck, the body, a shoulder, an arm, the thorax, the heart, the stomach, a blood vessel, a soft tissue, a knee, a foot, or the like, of a patient, or any combination thereof.

As described elsewhere in the present disclosure, dynamic PET imaging can provide a set of images (also referred to as image sequence) over a dynamic scan time. In particular, during a PET scan of an object, multiple sets of scan data of the object in a target time period may be obtained. Each set of the multiple sets of scan data may be collected in one of multiple sub-time periods in the target time period. In some embodiments, one or more reference images of the object may be obtained. The one or more reference images may be reconstructed based on reference scan data in one or more reference time periods of the PET scan. In some embodiments, the target time period may include the one or more reference time periods. Each set of the multiple sets of scan data and one of the one or more reference images may be used to generate a target image.

In some embodiments, a target image of the object corresponding to one of the multiple sub-time periods may be generated using an image reconstruction model based on one of the multiple sets of scan data generated in the one of the multiple sub-time periods and one of the one or more reference images of the object. For example, one of the multiple sets of scan data generated in the one of the multiple sub-time periods and one of the one or more reference images of the object may be inputted into the image reconstruction model, and the image reconstruction model may generate the target image and output the target image.

In some embodiments, a target image sequence of the object including multiple target images corresponding to the multiple sub-time periods may be generated using an image reconstruction model based on the multiple sets of scan data and the one or more reference images of the object. For example, the multiple sets of scan data generated in the multiple sub-time periods and the one or more reference images of the object may be inputted into the image reconstruction model, and the image reconstruction model may generate the target image sequence and output the target image sequence. The target image sequence may include multiple target images each of which is generated based on one set of the multiple sets of scan data and one of the one or more reference images. In some embodiments, an amount of the one or more reference images may be smaller than an amount of the multiple sub-time periods. In some embodiments, reference images for generating different target images may be the same or different.

For illustration purposes, the implementation of the generation of a target image corresponding to a sub-time period is described hereinafter.

In 310, the processing device 140 (e.g., the acquisition module 210) may obtain scan data of an object in a first time period of a PET scan of the object.

In some embodiments, the first time period may be one of the multiple sub-time period of the target time period. A duration of the first time period may be set manually by a user (e.g., an engineer) according to an experience value or a default setting of the PET system 100. Additionally or alternatively, the duration of the first time period may be determined by the processing device 140 according to an actual need (e.g., requirements on the total scan time, the imaging quality, etc.) Merely by way of example, the first time period may last for 5 seconds, 7 seconds, 10 seconds, or the like.

In some embodiments, the scan data may include event information of a plurality of coincidence events. In some embodiments, the plurality of coincidence events may include one or more truth coincidence events, one or more random coincidence events, one or more scatter coincidence events, or the like, or any combination thereof. For example, the event information of one of the plurality of coincidence events may include locations of two detector units (also referred to as a pair of detector units (e.g., the detector units 1181 shown in FIG. 11B)) detecting the coincidence event, LOR information (e.g., the location, the length, etc.) of a straight LOR corresponding to the coincidence event, TOF information of the coincidence event, energy information of two photons (also referred to as a pair of photons) of the coincidence event detected by detector units, detection time when the coincidence event is detected, or the like, or any combination thereof. The TOF information of the coincidence event may include a first TOF of a first photon of the coincidence event, a second TOF of a second photon of the coincidence event, a difference between the first TOF and the second TOF, or the like, or any combination thereof. In some embodiments, the scan data may include two-dimensional (2D) data or three-dimensional (3D) data.

In some embodiments, the scan data may be in forms of listmode, sinogram, histo-image (e.g., TOF histo-image), histo-projection (e.g., TOF histo-projection), etc. The scan data in form of listmode may be referred to as listmode data. In some embodiments, in the listmode data, information of a pair of detected photons corresponding to each coincidence event may be recorded and stored in a list format. For example, for a pair of photons of a coincidence event, information such as energy deposition locations of the two photons on the detector 118, the energy information of the two photons detected by detector units, and the detection time of the two photons by the two detector units may be recorded and stored in a list format. The scan data in form of sinogram may be referred to as sinogram data. In some embodiments, in the sinogram data, an accumulation of coincidence events corresponding to each LOR may be recorded and stored. The scan data in form of histo-image may be referred to as histo-image data. The histo-image data may be an image obtained by accumulating pixels corresponding to positions of multiple electron-positron annihilations determined based on time differences between two photons generated by the same electron-positron annihilation reaching two detector units in the image domain. The scan data in form of histo-projection may be referred to as histo-projection data. The histo-projection data may be an image generated by performing a direct back-projection operation on coincident events of a specific range of azimuths. A superposition of back-projected images of all angles may be equivalent to the back-projected images of all coincident events.

In some embodiments, the listmode data and/or the sinogram data may be converted into the histo-image data or the histo-projection data using various algorithms such as a direct projection algorithm or a TOF-based filtered backprojection algorithm. The histo-image data and the histo-projection data may be applied to a direct image reconstruction. The filtered backprojection algorithm may be a spatial processing technique based on Fourier transform theory. According to the filtered backprojection algorithm, the projection under each projection angle may be convolved before back-projection, so as to improve a shape artifact caused by a point spread function, and the quality of a reconstructed image generated using the filtered backprojection algorithm is relatively good. In particular, one-dimensional Fourier transform may be performed on projection data of an object obtained from a linear array detector, and then a convolution operation may be performed on the transformed projection data with a filter function to obtain the projection data in all directions. Further, a back-projection operation may be performed on the projection data after convolution and filtering in all directions to generate a tomographic image of the object. The direct projection algorithm may have a high efficiency and high throughput, and can achieve real-time imaging.

In some embodiments, the scan data may be collected by an imaging device (e.g., the PET scanner 110). The processing device 140 may obtain the scan data from one or more components (e.g., the PET scanner 110, the storage device 150) of the PET system 100 or an external source via a network (e.g., the network 120).

In 320, the processing device 140 (e.g., the acquisition module 210) may obtain a reference image of the object.

The reference image may be reconstructed based on reference scan data in a second time period of the PET scan.

In some embodiments, the second time period may be one of the one or more reference time periods. In some embodiments, the length of the second time period may be much greater than the length of the first time period. For example, if the scan time of the PET scan of the object is 30 minutes, the second time period may be greater than 2 minutes and the first time period may be smaller than 10 seconds. In such cases, sufficient and accurate reference data can be obtained in the second time period to obtain the reference image with a good imaging quality, and the dynamic PET imaging may be achieved in the first time period. In some embodiments, the second time period may include at least a portion of the first time period. In other words, the starting time and/or the ending time of the first time period may be located within the second time period.

In some embodiments, a duration of the second time period may be set manually by a user (e.g., an engineer) according to an experience value or a default setting of the PET system 100. Additionally or alternatively, the duration of the second time period may be determined by the processing device 140 according to an actual need (e.g., requirements on the total scan time, the imaging quality, etc.) Merely by way of example, the second time period may last for 1 minute, 2 minutes, 5 minutes, 6 minutes, or the like.

In some embodiments, the reference image of the object may be a PET image of the object that can be used for disease diagnosis, that is, the reference image may have a relatively good imaging quality. In some embodiments, the reference image of the object may be generated using a reconstruction algorithm such as a TOF-based reconstruction algorithm, a deep learning-based reconstruction algorithm, etc.

In some embodiments, the reference scan data may be obtained by performing a scatter correction on scan data in the second time period of the object. Accordingly, the reference image may be a scatter corrected PET image based on the reference scan data. In some embodiments, the processing device 140 may perform the scatter correction on scan data in the second time period using various scatter correction approaches. For example, the processing device 140 may perform the scatter correction on the scan data in the second time period using the scatter correction approaches involving multiple iterations as described elsewhere in the present disclosure. In some embodiments, the scan data in the second time period may be in form of histo-image. The processing device 140 may obtain an attenuation map of the object in the second time period. The processing device 140 may determine an activity map of a tracer for the PET scan using an activity map determination model based on the scan data in the second time period and the attenuation map of the object. Further, the processing device 140 may perform the scatter correction on the scan data in the second time period of the object based on the activity map. In some embodiments, the processing device 140 may determine a plurality of energy ranges of coincidence events generated in the second time period and a count of coincidence events corresponding to each of the plurality of energy ranges based on the scan data in the second time period. The processing device 140 may determine scatter estimation of a tracer for the PET scan in the second time period based on the plurality of energy ranges of coincidence events and the count of coincidence events corresponding to each of the plurality of energy ranges. Further, the processing device 140 may perform the scatter correction on the scan data in the second time period of the object based on the scatter estimation. More descriptions regarding the scatter correction may be found elsewhere in the present disclosure (e.g., FIG. 4 and FIG. 5, and the descriptions thereof).

In some embodiments, the reference image may be performed, such as a motion correction, to further improve the accuracy of the reference image. In some embodiments, the processing device 140 may obtain a plurality of candidate reference images from the one or more reference images. For each of the plurality of candidate reference images, the processing device 140 may determine a weight corresponding to the candidate reference image. Further, the processing device 140 may determine the reference image based on the plurality of candidate reference images and the weights corresponding to the plurality of candidate reference images. For example, the processing device 140 may determine a weighted sum of the plurality of candidate reference images and corresponding weights as the reference image.

In some embodiments, the processing device 140 may determine the weights corresponding to the plurality of candidate reference images based on the reference time periods corresponding to the plurality of candidate reference images and the first time period. For example, if a first reference time period corresponding to a first candidate reference image includes at least a portion of the first time period, and a second reference time period corresponding to a second candidate reference image does not include at least a portion of the first time period, a first weight corresponding to the first candidate reference image may be greater than the second weight corresponding to the second candidate reference image. If the more a reference time period corresponding to a candidate reference image overlaps with the first time period, the greater the weight corresponding to the candidate reference image may be. If a reference time period corresponding to a candidate reference image does not overlap with the first time period, the smaller an interval time period between the reference time period and the first time period, the greater the weight corresponding to the candidate reference image may be. In this way, the reference image may have a greater accuracy, thereby improving the accuracy of the subsequent target image generated based on the reference image.

In 330, the processing device 140 (e.g., the determination module 230) may generate, based on the scan data in the first time period and the reference image of the object, a target image of the object in the first time period using an image reconstruction model.

In the same PET scan of the object, an attenuation map may remain unchanged if there is no obvious motion of the object (e.g., a magnitude of the motion of the object is smaller than a magnitude threshold). Therefore, a scatter correction kernel may be extracted based on the reference image. Further, the target image of the object generated based on the scan data in the first time period and the reference image may have a relatively high accuracy.

In some embodiments, the image reconstruction model may be a trained model (e.g., a trained machine learning model) used for reconstructing a PET image of an object. Merely by way of example, the scan data in the first time period and the reference image of the object may be input into the image reconstruction model, and the image reconstruction model may output the target image of the object. In some embodiments, a plurality of sets of scan data corresponding to a plurality of first time periods and one or more reference images may be input into the image reconstruction model, and the image reconstruction model may output a plurality of target images (i.e., a dynamic image or an image sequence) of the object corresponding to the plurality of first time periods.

In some embodiments, the processing device 140 may obtain corrected scan data by performing a correction on the scan data in the first time period. The correction may include an attenuation correction, a random correction, or a normalization correction, a preliminary scatter correction based on energy information, or the like, or any combination thereof. In some embodiments, the random correction may be achieved by projecting random data in the scan data relating to the one or more random coincidence events into an image domain. The normalization correction may be achieved by multiplying the scan data by efficiency factors of the detector units of the detector 118. The efficiency factors of the detector units may be obtained by analyzing a large amount of scan data acquired by scanning a uniform source with the PET scanner 110. The attenuation correction refers to a correction for the attenuation of gamma rays by the object to obtain the true activity map of the trace and quantify it. The preliminary scatter correction based on energy information may be achieved by projecting scattering projection data corresponding to different energy spectra into an image domain. In some embodiments, the correction may also include other corrections such as a motion artifact correction, a point spread correction, a low signal correction, a sparse reconstruction correction, etc.

In some embodiments, the processing device 140 may determine one or more corrections that need to be performed on the scan data based on the scan data. For example, the processing device 140 may generate an initial reconstruction image based on the scan data. Then, the processing device 140 may determine the one or more corrections that need to be performed on the scan data based on the initial reconstruction image using a correction determination model. Merely by way of example, the initial reconstruction image, the scan data, and reconstruction requirements for the target image (e.g., a requirement for clarity of the target image) may be input into the correction determination model, and the correction determination model may output the one or more corrections that need to be performed on the scan data.

Further, the processing device 140 may determine the target image of the object using the image reconstruction model based on the corrected scan data and the reference image of the object. Merely by way of example, the corrected scan data and the reference image of the object may be input into the image reconstruction model, and the image reconstruction model may output the target image of the object. In this way, compared with target image generated based on the scan data and the reference image, the target image generated based on the corrected scan data and the reference image may have a greater accuracy.

In some embodiments, the image reconstruction model may be constructed based on a linear regression model, a ridge regression model, a support vector regression model, a support vector machine model, a decision tree model, a fully connected neural network model, a recurrent neural network model, a deep neural network (DNN) model, a convolutional neural network (CNN) model, a recurrent neural network (RNN) model, a feature pyramid network (FPN) model, a deep belief network (DBN) model, a generative adversarial network (GAN) model, or the like, or any combination thereof. In some embodiments, the image reconstruction model may include a 2DU-net network structure, a 3D U-net network structure, a U-net++ network structure, a U-net3+ network structure, a V-net network structure, etc.

In some embodiments, the processing device 140 may obtain the image reconstruction model from one or more components of the PET system 100 (e.g., the storage device 150, the terminals 130) or an external source via a network (e.g., the network 120). For example, the image reconstruction model may be previously trained by a computing device (e.g., the processing device 140), and stored in a storage device (e.g., the storage device 150) of the PET system 100. The processing device 140 may access the storage device and retrieve the image reconstruction model. In some embodiments, the image reconstruction model may be generated according to a machine learning algorithm. The machine learning algorithm may include but not be limited to an artificial neural network algorithm, a deep learning algorithm, a decision tree algorithm, an association rule algorithm, an inductive logic programming algorithm, a support vector machine algorithm, or the like, or any combination thereof.

Merely by way of example, the processing device 140 may obtain one or more first training samples. Each first training sample may include first sample scan data of a first sample object in a sample first time period, a sample reference image of the first sample object, and a sample target image of the first sample object in the sample first time period. The sample reference image may be reconstructed based on sample reference scan data obtained by performing a scatter correction on sample scan data of the first sample object in a sample second time period. In some embodiments, the first sample scan data may include histo-image data, histo-projection data, listmode data, or sinogram data. In some embodiments, the first sample scan data and the sample reference image may be obtained in a similar manner as how the scan data in the first time period and the reference image are obtained as described in connection with operations 310 and 320. In some embodiments, the sample target image of the first sample object may be generated using various methods such as the conventional PET image reconstruction methods as described elsewhere in the present disclosure. Further, the processing device 140 may generate the image reconstruction model by training a first preliminary model using the one or more first training samples. In some embodiments, if the first sample scan data is histo-image data or histo-projection data, during the training of the first preliminary model, a direct image reconstruction algorithm may be used for performing PET image reconstruction, thereby obtaining the image reconstruction model for direct image reconstruction. Since the first preliminary model may learn the optimal mechanism for PET image reconstruction by extracting scatter correction kernels based on the sample reference images during the training, therefore the target image generated using the image reconstruction model may be relatively accurate.

As described elsewhere in the present disclosure, the conventional dynamic PET imaging approaches involve one or more iterations or need to obtain scatter corrected scan data for generating each image individually, which is computationally intensive and inefficient. Compared with the conventional dynamic PET imaging approaches, according to some embodiments of the present disclosure, the target image sequence including multiple target images may be generated using only a small number of reference images (e.g., one reference image), which may not only obtain accuracy target images but also greatly improve the efficiency of the dynamic PET imaging. In additional, in some embodiments, the image reconstruction model may be used for direct image reconstruction, thereby further improving the efficiency of the dynamic PET imaging by using the image reconstruction model.

As described elsewhere in the present disclosure, compton scatter is a major image quality and quantitation degradation factor in PET that should be accounted for during high quality image reconstruction. A scatter coincidence event may be recorded when at least one of the two photons generated by an electron-positron annihilation undergoes one or more scatters due to the Compton effect, and the two photons are detected within a coincidence time window (e.g., within 6 to 12 nanoseconds).

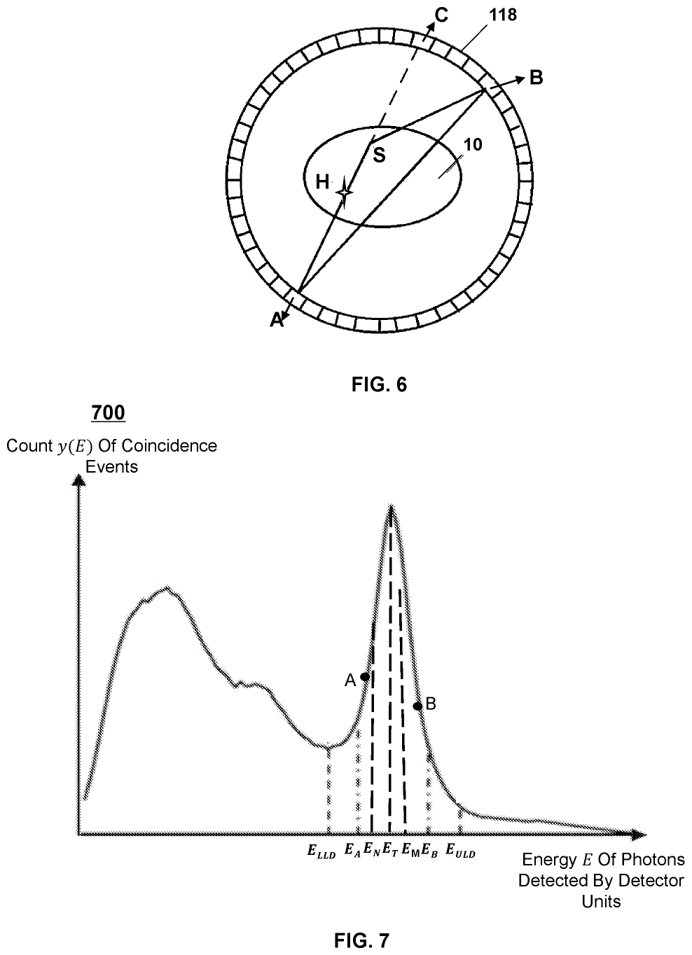

For example, FIG. 6 is a schematic diagram illustrating an exemplary scatter coincidence event according to some embodiments of the present disclosure. As shown in FIG. 6, a detector ring 118 of the PET scanner 110 may include a plurality of detector units. An electron-positron annihilation occurs at point H and simultaneously generate two photons L and R traveling in opposite directions along a line. The photon L travels towards detector unit A through path HA, and is detected by the detector unit A. The photon R travels towards detector unit C through path HC. However, when the photon R travel to point S, the photon R undergoes Compton scatter, which changes the direction of the traveling of the photon R to travel towards detector unit B through a path SB and is detected by the detector unit B. In this case, a scatter coincidence event corresponding to the photons L and R may be recorded. If the scatter coincidence event corresponding to the photons L and R is not corrected, the electron-positron annihilation that generates photons L and R occurs on an LOR connecting the detector unit A and the detector unit B. A large number of scatter coincidence events will result in PET images with poor quality.

Therefore, a scatter correction of scan data of a PET scan is vital for PET image reconstruction.

FIG. 4 is a flowchart illustrating an exemplary process for scatter correction according to some embodiments of the present disclosure.

In 410, the processing device 140 (e.g., the acquisition module 210) may obtain scan data of an object of a PET scan of an object. The scan data may be in form of histo-image, that is, the scan data may be histo-image data.

In some embodiments, the scan data of the object may be PET scan data that needs to receive the scatter correction. For example, the scan data may be the scan data in the second time period as described in connection with operation 320. In some embodiments, the obtaining of the scan data may be performed in a similar manner as that of the first scan data as described in connection with operation 310.

In some embodiments, if the scan data is other forms other than histo-image data (e.g., listmode data or sinogram data), the processing device 140 may convert the scan data into histo-image data.

In some embodiments, the processing device 140 may obtain corrected scan data by performing a correction on the scan data. In some embodiments, the correction of the scan data may be performed in a similar manner as that of the first scan data as described in connection with operation 330.

In some embodiments, if the PET scan (e.g., a PET scan of the entire body of the object with a short-axis PET system) includes a plurality of sub scans corresponding to different positions of a table (e.g., the table 116) on which the object is supported relative to the imaging device (e.g., the PET scanner 110) for the PET scan. The scan data may be scan data obtained by each of the plurality of sub scans. In this way, scan data obtained by different sub scans may be individually performed the scatter correction to avoid mutual interference, thereby subsequently obtaining accurate scatter estimation corresponding to each sub scan.

In 420, the processing device 140 (e.g., the acquisition module 210) may obtain an attenuation map of the object.

In a PET scan, attenuation to various extents may occur when γ-rays pass through different tissues of a subject because the attenuation degrees of different tissues to γ-rays are different, causing distortion of a PET image and/or PET scan data. To reconstruct a PET image and/or PET data, the attenuation may be corrected. An attenuation map may be generated in the process of attenuation correction.

In some embodiments, the attenuation map may be acquired through a scan using a computed tomography (CT) scanner or a magnetic resonance (MR) scanner. For example, a CT scan may be performed before the PET scan, and then a CT image may be generated. The attenuation image may be generated based on tissue attenuation information of the object obtained via the CT image. As another example, the attenuation map may be generated based on an ultrashort echo-time (UTE) sequence of MR scan.

In some embodiments, the processing device 140 may generate the attenuation map. The processing device 140 may generate the attenuation map based on one or more algorithms including, for example, an iterative reconstruction algorithm, a filtered back projection (FBP) algorithm, a 3D reconstruction algorithm, etc. In some embodiments, the attenuation map may be previously generated and stored in a storage device (e.g., the storage device 150, or an external source). The processing device 140 may retrieve the attenuation map directly from the storage device.

In 430, the processing device 140 (e.g., the determination module 230) may determine, based on the scan data (or corrected scan data) and the attenuation map of the object, an activity map of a tracer for the PET scan using an activity map determination model.

In some embodiments, different positions of the object may have different uptake of the tracer, that is, different counts of the annihilation events have occurred at different positions of the subject. The activity map of the tracer may indicate a distribution of the uptake of the tracer at different positions of the object or a distribution of the annihilation events having occurred at different positions of the object. Take a living object as an example, the uptake of the tracer in different parts of the living object may relate to a physiological property of each of the parts of the living object. For example, the head or the bladder may each have a higher uptake of the tracer than other parts of the living object. As another example, a part of the living object with a tumor (e.g., a benign tumor, a malignant tumor) may have a higher uptake of the tracer compared to a reference uptake.

In some embodiments, the activity map determination model may be a trained model (e.g., a trained machine learning model) used for determining an activity map of a tracer for PET scan. Merely by way of example, the scan data (or corrected scan data) and the attenuation map of the object may be input into the activity map determination model, and the activity map determination model may output the activity map of the tracer.

In some embodiments, the activity map determination model may be constructed based on a linear regression model, a ridge regression model, a support vector regression model, a support vector machine model, a decision tree model, a fully connected neural network model, a recurrent neural network model, a deep neural network (DNN) model, a convolutional neural network (CNN) model, a recurrent neural network (RNN) model, a feature pyramid network (FPN) model, a deep belief network (DBN) model, a generative adversarial network (GAN) model, or the like, or any combination thereof. In some embodiments, the activity map determination model may include a 2DU-net network structure, a 3D U-net network structure, a U-net++ network structure, a U-net3+ network structure, a V-net network structure, etc.

In some embodiments, different portions (e.g., the head, the abdomen, the entire body, etc.) of the object may correspond to different activity map determination models. The activity map determination models for determining activity maps corresponding to different portions (e.g., the head, the abdomen, the entire body, etc.) of the object may have different model parameters or the same model parameters.

In some embodiments, the processing device 140 may obtain the activity map determination model in a similar manner as the obtaining of the image reconstruction model as described in connection with operation 330. In some embodiments, the activity map determination model may be generated according to a machine learning algorithm.

Merely by way of example, the processing device 140 may obtain one or more second training samples. Each of the one or more second training samples may be obtained by performing a sample PET scan on a second sample object. In some embodiments, each second training sample may include second sample scan data of the second sample object, a sample attenuation map of the second sample object, and a reference activity map of a tracer for the sample PET scan. The second sample scan data may be in form of histo-image. In some embodiments, the second sample scan data and the sample attenuation map may be obtained in a similar manner as how the scan data and the attenuation map are obtained as described in connection with operations 410 and 420. The reference activity map may be generated using various approaches such as the conventional scatter correction approaches as described elsewhere in the present disclosure. For example, the reference activity map may be generated according to an ordered subsets expectation maximization (OSEM) algorithm. In particular, the second sample scan data may be divided into a plurality of subsets. For each subset, all pixel values may be updated with the scan data of the subset, and an iteration may be completed until all subsets is used up. After each iteration, the activity map may converge a little, and the reference activity map may be determined via one or more iterations.

Further, the processing device 140 may generate the activity distribution determination mode by training a second preliminary model using the one or more second training samples. The sample attenuation map may include sample attenuation coefficients corresponding to different portions of the second sample object, and the subsequent scatter correction may be performed based on the activity map and the attenuation map. Therefore, according to some embodiments of the present disclosure, each second training sample may the sample attenuation map, which is important information to the model training, and may enhance the robustness of the training model.

In 440, the processing device 140 (e.g., the performing module 240) may perform, based on the activity map, a scatter correction on the scan data.

In some embodiments, the processing device 140 may determine a scatter estimation of the tracer based on the attenuation map and the activity map of the tracer. In some embodiments, the scatter estimation of the tracer may be determined based on the activity map and the attenuation map using a scatter correction algorithm. Exemplary scatter correction algorithms may include a single scatter simulation (SSS) algorithm, a Monte-Carlo simulation (MCS) algorithm, a double scatter simulation (DSS) algorithm, or the like. The scatter estimation may be used for TOF image reconstruction or non-TOF image reconstruction of the PET scan. The scatter estimation may be in forms of sinogram or list-mode. Further, the processing device 140 may perform the scatter correction on the scan data based on the scatter estimation to obtain scatter correction data of the scan data (e.g., the reference scan data described in connection with operation 320). For example, the processing device 140 may update the scan data by removing information relating to the scatter coincidence events from the scan data, or compensating the scan data based on the scatter estimation to obtain scatter correction data of the scan data.

As described elsewhere in the present disclosure, some conventional scatter correction approaches usually involve multiple iterations for obtaining an accurate activity map, which is inefficient. Compared with the conventional scatter correction approaches, according to some embodiments of the present disclosure, the activity map of the tracer may be determined based on the scan data (or corrected scan data) and the attenuation map of the object using the activity map determination model, which is more efficient by reducing the amount of data processing, thereby improving the efficiency of the scatter correction. Moreover, during the training of the second preliminary model, since the second preliminary model may learn the optimal mechanism for generating an activity map based on the one or more second training samples, therefore the activity map generated using the activity map determination mode may be relatively accurate, thereby improving or ensuring the accuracy of the scatter correction.

FIG. 5 is a flowchart illustrating another exemplary process for scatter correction according to some embodiments of the present disclosure.

In 510, the processing device 140 (e.g., the acquisition module 210) may obtain scan data of an object of a PET scan of the object.

In some embodiments, the scan data of the object may be PET scan data that needs to be performed the scatter correction. For example, the scan data may be the scan data in the second time period as described in connection with operation 320. In some embodiments, the obtaining of the scan data may be performed in a similar manner as that of the first scan data as described in connection with operation 310.

In some embodiments, the scan data may be in form of list-mode, that is, the scan data may be list-mode data. As described elsewhere in the present disclosure, in the list-mode data, information of a pair of detected photons corresponding to each coincidence event may be recorded and stored in a list format. For example, for a pair of photons of a coincidence event, information such as energy deposition locations of the two photons on the detector 118, the energy information of the two photons detected by detector units, and the detection time of the two photons by the two detector units may be recorded and stored in a list format.

In 520, the processing device 140 (e.g., the determination module 230) may determine, based on the scan data, a plurality of energy ranges of coincidence events generated in the PET scan.

As used herein, the energy information of a coincidence event refers to the energy information of the photons of the coincidence event detected by detector units, that is, energy value detected by detector units corresponding to the photons of the coincidence event. The plurality of energy ranges may be used for determining scatter coincidence events of the PET scan. In some embodiments, the plurality of energy ranges of coincidence events may include one or more reference energy ranges. Energy values in at least one of the one or more reference energy ranges may be smaller than an energy value (e.g., 511 keV) corresponding to the true coincidence event. In some embodiments, the coincidence events corresponding to at least one of the one or more reference energy ranges may be substantially scatter coincidence events.

Merely by way of example, the one or more reference energy ranges may include a first energy range and a second energy range. The processing device 140 may obtain a minimum energy value and a maximum energy value base on a coincidence energy window for determining coincidence events of the PET scan. In some embodiments, the coincidence energy window may be set by a default setting of the PET system 100, or determined by the processing device 140 or a user (e.g., an engineer) according to an actual need. The processing device 140 may respectively designate a minimum and a maximum of energy values in the coincidence energy window as the minimum energy value and the maximum energy value. In some embodiments, the processing device 140 may determine the minimum energy value and the maximum energy value based on the energy value (e.g., 511 keV) of the true coincidence event and a standard deviation of an energy resolution of a PET scanner (e.g., the PET scanner 110) for the PET scan. For example, the processing device 140 may determine a first energy threshold based on the standard deviation of the energy resolution. Then, the processing device 140 may designate a difference obtained by subtracting the first energy threshold from the energy value of the true coincidence event as the minimum energy value, and designate a sum of the energy value of the true coincidence event and the first energy threshold as the maximum energy value. For example, if the energy value of the true coincidence event is 511 keV and the first energy threshold is 3σ, the minimum energy value may be 511−3σ and the maximum energy value may be 511+3σ, wherein σ denotes the standard deviation of the energy resolution of the PET scanner.

Further, the processing device 140 may determine a first energy value and a second energy value. The first energy value may be smaller than the energy value corresponding to the true coincidence event and the second energy value may be greater than the energy value corresponding to the true coincidence event. In some embodiments, the processing device 140 may determine the first energy value and the second energy value based on the energy value (e.g., 511 keV) of the true coincidence event and the standard deviation of the energy resolution of the PET scanner for the PET scan. For example, the processing device 140 may determine a second energy threshold based on the standard deviation of the energy resolution. Then, the processing device 140 may designate a difference obtained by subtracting the second energy threshold from the energy value of the true coincidence event as the first energy value, and designate a sum of the energy value of the true coincidence event and the second energy threshold as the second energy value. For example, if the energy value of the true coincidence event is 511 keV and the first energy threshold is 2σ, the first energy value may be 511−2σ and the second energy value may be 511+2σ. If the energy resolution of the PET scanner for the PET scan is 12% and satisfy a Gaussian distribution, the standard deviation a may be 26 keV. Accordingly, the first energy value may be equal to 459 keV and the second energy value may be equal to 563 keV. In some embodiments, the first energy threshold may be greater than the second energy threshold.

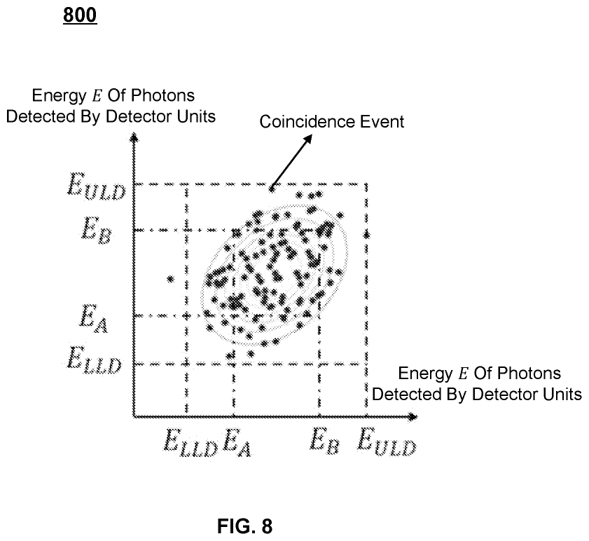

For example, FIG. 7 is a schematic diagram illustrating an exemplary 1D energy spectrum 700 of a PET scan according to some embodiments of the present disclosure. FIG. 8 is a schematic diagram illustrating an exemplary 2D energy spectrum 800 of a PET scan according to some embodiments of the present disclosure. An energy spectrum of a PET scan may reflect a distribution of a count of coincidence events in the PET scan as energy of photons detected by detector units. As shown in FIG. 7, a horizontal axis of the energy spectrum 700 represents energy E of the photons detected by detector units, and a vertical axis of the energy spectrum 700 represents a count y(E) of coincidence events with the same energy. As shown in FIG. 8, a horizontal axis and a vertical axis of the energy spectrum 800 represent energies E of the photons detected by detector units. Solid dots represent coincidence events. For each solid dot, the horizontal coordinate and the vertical coordinate corresponding to the solid dot represent energies of the two photons of the coincidence event corresponding to the solid dot detected by detector units. An energy E_{LLD} as shown in FIG. 7 and FIG. 8 may be minimum energy value and an energy E_{ULD} as shown in FIG. 7 and FIG. 8 may be the maximum energy value. An energy E_{A} as shown in FIG. 7 and FIG. 8 may be the first energy value and an energy E_{B} as shown in FIG. 7 and FIG. 8 may be the second energy value.

In some embodiments, the processing device 140 may determine the first and second energy values based on a slope of a curve representing the 1D energy spectrum. For example, as shown in FIG. 7, the processing device 140 may determine an energy value corresponding to a point A with a largest slope on a curve segment corresponding to an energy range from the E_{LLD} to the energy E_{T} of the true coincidence event as the first energy value. The processing device 140 may determine an energy value corresponding to a point B with a smallest slope on a curve segment corresponding to an energy range from the energy E_{T} of the true coincidence event to the E_{ULD} as the second energy value.

Then, the processing device 140 may determine the first energy range and the second energy range based on the minimum energy value, the maximum energy value, the first energy value, and the second energy value. In particular, the processing device 140 may determine an energy range from the minimum energy value to the first energy value as the first energy range (e.g., the E_{LLD}<E_{A}) and determine an energy range from the second energy value to the maximum energy value as the second energy range (e.g., E_{ULD}<E_{B}).

In 530, the processing device 140 (e.g., the determination module 230) may determine, based on the plurality of energy ranges of coincidence events, a scatter estimation (also referred to as first scatter estimation) of a tracer for the PET scan.

In some embodiments, the scatter estimation may indicate a count of scatter coincidence events corresponding to the coincidence energy window. In some embodiments, the scatter estimation may be in a form of sinogram. In some embodiments, the processing device 140 may obtain a count of coincidence events corresponding to each of the one or more reference energy ranges based on the scan data. Further, the processing device 140 may determine the scatter estimation based on the plurality of energy ranges and the count of coincidence events corresponding to each of the one or more reference energy ranges. For illustration purposes, the determination of the scatter estimation based on the first energy range and the second energy range is described hereinafter. For brevity, the minimum energy value and the maximum energy value are the minimum and the maximum of energy values in the coincidence energy window, respectively.

In some embodiments, the processing device 140 may determine the scatter estimation based on a first length of the first energy range, a second length of the second energy range and a count of coincidence events corresponding to the first energy range and the second energy range. As used herein, an energy range includes a starting energy value (i.e., a minimum energy value) and an ending energy value (i.e., a maximum energy value), a length of the energy range refers to a difference between the maximum energy value and the minimum energy value of the energy range.

In some embodiments, the processing device 140 may determine a third energy range between the first energy range and the second energy range. Further, the processing device 140 may determine the scatter estimation based on the first length, the second length, a third length of the third energy range, and the count of coincidence events corresponding to the first energy range and the second energy range.

For example, as shown in FIG. 7, for the 1D energy spectrum, the processing device 140 may determine the count of scatter coincidence events corresponding to the third energy range from the energy E_{A} to energy E_{B} according to Equation (1) as below:

$$SC = {Counts}_{{E}_{LLD} < E < {E}_{A} ⋃ {E}_{B} < E < {E}_{ULD}} \times \frac{{E}_{B} - {E}_{A}}{{E}_{ULD} - {E}_{B} + {E}_{A} - {E}_{LLD}} , \qquad ( 1 )$$

where SC denotes the count of scatter coincidence events corresponding to the third energy range, CountS_{E}_{_{LLD}}_{<E<E}_{_{A}}_{∪E}_{_{B}}_{<E<E}_{_{ULD}} denotes the count of coincidence events corresponding to the first energy range and the second energy range, E_{B}-E_{A} denotes a third length of the third energy range, E_{ULD}-E_{B} denotes the second length of the second energy range, and E_{A}-E_{LLD} denotes the first length of the first energy range.

In some embodiments, as shown in FIG. 7, for the 1D energy spectrum, the processing device 140 may determine a fourth energy range from the energy E_{N} to the energy E_{M} based on the energy of the true coincidence event. Coincidence events corresponding to the fourth energy range may be considered as true coincidence events or approximate true coincidence events. In some embodiments, the energy E_{N} and the energy E_{M} may be set according to actual needs. Further, the processing device 140 may determine the count of scatter coincidence events corresponding to the third energy range from the energy E_{A} to the energy E_{B} according to Equation (2) as below:

$$C = {Counts}_{{E}_{LLD} < E < {E}_{A} ⋃ {E}_{B} < E < {E}_{ULD}} \times \frac{{\int }_{{E}_{A}}^{{E}_{B}} y ( E ) dE - {\int }_{{E}_{N}}^{{E}_{M}} y ( E ) dE}{{\int }_{{E}_{B}}^{{E}_{ULD}} y ( E ) dE + {\int }_{{E}_{LLD}}^{{E}_{A}} y ( E ) dE} . \qquad ( 2 )$$

As another example, as shown in FIG. 8, for the 2D energy spectrum, the processing device 140 may determine the count of scatter coincidence events corresponding to the third energy range from the energy E_{A} to the energy E_{B} according to Equation (3) as below:

$$C = {Counts}_{{E}_{LLD} < E < {E}_{A} ⋃ {E}_{B} < E < {E}_{ULD}} \times \frac{{( {E}_{B} - {E}_{A} )}^{2}}{{( {E}_{ULD} - {E}_{LLD} )}^{2} - {( {E}_{B} - {E}_{A} )}^{2}} , \qquad ( 3 )$$

where E_{ULD}-E_{LLD} denotes a fourth length of the coincidence energy widow.

Further, the processing device 140 may determine a sum of the count of coincidence events corresponding to the first energy range, the count of coincidence events corresponding to the second energy range, and the count of the scatter coincidence events corresponding to the third energy range as the scatter estimation.

In some embodiments, the processing device 140 may determine the scatter estimation base on the first length, the second length, the fourth length of the coincidence energy window, and the count of coincidence events corresponding to the first energy range and the second energy range.

For example, as shown in FIG. 7, for the 1D energy spectrum, the processing device 140 may determine the scatter estimation according to Equation (4) as below:

$${SC}_{1} = {Counts}_{{E}_{LLD} < E < {E}_{A} ⋃ {E}_{B} < E < {E}_{ULD}} \times \frac{{E}_{ULD} - {E}_{LLD}}{{E}_{ULD} - {E}_{B} + {E}_{A} - {E}_{LLD}} , \qquad ( 4 )$$

where SC₁ denotes the count of scatter coincidence events corresponding to the coincidence energy window (i.e., the scatter estimation).

As another example, as shown in FIG. 8, for the 2D energy spectrum, the processing device 140 may determine the scatter estimation according to Equation (5) as below:

$${SC}_{1} = {Counts}_{{E}_{LLD} < E < {E}_{A} ⋃ {E}_{B} < E < {E}_{ULD}} \times \frac{{( {E}_{ULD} - {E}_{LLD} )}^{2}}{{( {E}_{ULD} - {E}_{LLD} )}^{2} - {( {E}_{B} - {E}_{A} )}^{2}} . \qquad ( 5 )$$

In 540, the processing device 140 (e.g., the performing module 240) may perform, based on the scatter estimation, a scatter correction on the scan data.

In some embodiments, the processing device 140 may correct the scatter estimation to obtain the corrected scatter estimation. For example, the processing device 140 may perform a filtering operation and/or noise reduction operation on the scatter estimation in a form of sinogram to obtain the corrected scatter estimation. As another example, the processing device 140 may correct the scatter estimation based on experimental data and characteristic information of the scatter estimation to obtain the corrected scatter estimation. Exemplary characteristic information of the scatter estimation may include a ratio of the count of coincidence events corresponding to the first energy range to the count of coincidence events corresponding to the second energy range, a ratio of the first length to the third length, a ratio of the second length to the third length, or the like, or any combination thereof.

In some embodiments, the processing device 140 may perform a preliminary scatter correction on the scan data using the scatter estimation or the corrected scatter estimation to obtain preliminary scatter correction data of the scan data. For example, the processing device 140 may update the scan data by removing information relating to the scatter coincidence events from the scan data, or compensating the scan data based on the scatter estimation to obtain the preliminary scatter correction data of the scan data. In some embodiments, the processing device 140 may designate the preliminary scatter correction data of the scan data as the scatter correction data of the scan data.

In some embodiments, the processing device 140 may perform one or more iterations until a termination condition is satisfied based on the preliminary scatter correction data. In each of the one or more iterations, the processing device 140 may reconstruct an activity map of a tracer for the PET scan based on the preliminary scatter correction data (or updated scatter correction data) using one or more algorithms including, for example, a filtered back projection (FBP) algorithm, an ordered subset expectation maximum (OSEM) algorithm, etc. In some embodiments, the processing device 140 may reconstruct the activity map of the tracer based on the preliminary scatter correction data (or updated scatter correction data) and TOF information of the scan data. In some embodiments, the processing device 140 may optimize the activity map using a deep learning model to obtain an optimized activity map with a greater accuracy than the activity map. The processing device 140 may obtain an attenuation map in a similar manner as described in connection with operation 420. Further, the processing device 140 may determine a second scatter estimation of the tracer based on the attenuation map and the activity map (or the optimized activity map)) of the tracer. In some embodiments, the second scatter estimation may be determined in a similar manner as the determination of the scatter estimation of the tracer as described in connection with operation 440. Further, the processing device 140 may perform the scatter correction on the scan data based on the second scatter estimation to obtain the scatter correction data of the scan data (e.g., the reference scan data described in connection with operation 320). Exemplary termination conditions may include that a difference between the scatter estimations obtained in a previous iteration and the current iteration is less than a certain threshold, a maximum number (or count) of iterations has been performed, or the like, or any combination thereof.

As described elsewhere in the present disclosure, some conventional scatter correction approaches usually involve multiple iterations for obtaining an accurate activity map, which are inefficient. Some conventional scatter correction approaches based on energy information requires high statistics and have not yet been applied in clinical use or have a limited accuracy.

Compared with the conventional scatter correction approaches usually involve multiple iterations, according to some embodiments of the present disclosure, the processing device 140 may determine the first scatter estimation of the scan data based on the plurality of energy ranges and the count of coincidence events corresponding to each of the one or more reference energy ranges, and further perform the scatter correction on the scan data based on the first scatter estimation, which is more efficient by reducing the amount of data processing, thereby improving the efficiency of the scatter correction.

Compared with the conventional scatter correction approaches based on energy information, according to some embodiments of the present disclosure, since the coincidence events corresponding to at least one in the one or more reference energy ranges may be substantially scatter coincidence events, the first scatter estimation determined based on the plurality of energy ranges and the count of coincidence events corresponding to each of the one or more reference energy ranges may be relatively accurate, thereby the scatter correction having an improved accuracy. In some embodiments, the processing device 140 may perform the scatter correction on the scan data using the second scatter estimation, which have a more accuracy. Moreover, the scatter correction method disclosed in the present disclosure may only involve a small amount of data processing and have a strong practicability, which may be applied in clinical use.

It will be apparent to those skilled in the art that various changes and modifications can be made in the present disclosure without departing from the spirit and scope of the disclosure. In this manner, the present disclosure may be intended to include such modifications and variations if the modifications and variations of the present disclosure are within the scope of the appended claims and the equivalents thereof. For example, the operations of the illustrated processes 300, 400, and 500 are intended to be illustrative. In some embodiments, the processes 300, 400, and 500 may be accomplished with one or more additional operations not described, and/or without one or more of the operations discussed. Additionally, the order in which the operations of the processes 300, 400, and 500 and regarding descriptions are not intended to be limiting.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, VB. NET, Python or the like, conventional procedural programming languages, such as the “C” programming language, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed object matter requires more features than are expressly recited in each claim. Rather, claim object matter lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate a certain variation (e.g., 1%, 5%, 10%, or +20%) of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable. In some embodiments, a classification condition used in classification or determination is provided for illustration purposes and modified according to different situations. For example, a classification condition that “a value is greater than the threshold value” may further include or exclude a condition that “the probability value is equal to the threshold value.”

1. A system for positron emission tomography (PET) imaging, comprising:
at least one storage device including a set of instructions; and
at least one processor in communication with the at least one storage device, wherein when executing the set of instructions, the at least one processor is configured to direct the system to perform operations including:
obtaining scan data of an object in a first time period of a PET scan of the object;
obtaining a reference image of the object, wherein the reference image is reconstructed based on reference scan data in a second time period of the PET scan; and
generating, based on the scan data in the first time period and the reference image of the object, a target image of the object in the first time period using an image reconstruction model.

2. The system of claim 1, wherein the second time period includes at least a portion of the first time period.

3. The system of claim 1, wherein the scan data of the object is in form of histo-image.

4. The system of claim 1, wherein the generating, based on the scan data in the first time period and the reference image of the object, a target image of the object in the first time period using an image reconstruction model includes:
obtaining corrected scan data by performing a correction on the scan data in the first time period, the correction including at least one of an attenuation correction, a random correction, or a normalization correction; and
generating, based on the corrected scan data and the reference image of the object, the target image of the object using the image reconstruction model.

5. The system of claim 1, wherein the reference scan data is obtained by performing a scatter correction on scan data in the second time period of the object.

6. The system of claim 1, wherein the image reconstruction model is generated according to a training process including:
obtaining one or more first training samples each of which includes first sample scan data of a first sample object in a sample first time period, a sample reference image of the first sample object, and a sample target image of the first sample object in the sample first time period, wherein the sample reference image is reconstructed based on sample reference scan data obtained by performing a scatter correction on sample scan data of the first sample object in a sample second time period; and
generating the image reconstruction model by training a first preliminary model using the one or more first training samples.

7. The system of claim 5, wherein the scan data in the second time period is in form of histo-image, and the scatter correction includes:
obtaining an attenuation map of the object in the second time period,
determining, based on the scan data in the second time period and the attenuation map of the object, an activity map of a tracer for the PET scan using an activity map determination model; and
performing, based on the activity map, the scatter correction on the scan data in the second time period of the object.

8. The system of claim 7, wherein the performing, based on the activity map, the scatter correction on the scan data in the second time period of the object includes:
determining, based on the attenuation map and the activity map of the tracer, a scatter estimation of the tracer; and
performing, based on the scatter estimation, the scatter correction on the scan data in the second time period of the object.

9. The system of claim 7, wherein the activity map determination mode is generated according to a training process including:
obtaining one or more second training samples each of which includes second sample scan data of a second sample object, a sample attenuation map of the second sample object, and a reference activity map of a tracer, wherein the second sample scan data is in form of histo-image; and
generating the activity map determination mode by training a second preliminary model using the one or more second training samples.

10. The system of claim 5, wherein the scatter correction includes:
determining, based on the scan data in the second time period, a plurality of energy ranges of coincidence events generated in the second time period;
determining, based on the plurality of energy ranges of coincidence events, scatter estimation of a tracer for the PET scan in the second time period; and
performing, based on the scatter estimation, the scatter correction on the scan data in the second time period of the object.

11. The system of claim 10, wherein the determining, based on the plurality of energy ranges of coincidence events, scatter estimation of a tracer for the PET scan in the second time period includes:
obtaining, based on the scan data in the second time period, a count of coincidence events corresponding to each of one or more reference energy ranges among the plurality of energy ranges of coincidence events, wherein energy values in at least one of the one or more reference energy ranges are smaller than an energy value corresponding to a true coincidence event;
determining, based on the plurality of energy ranges and the count of coincidence events corresponding to each of the one or more reference energy ranges, the scatter estimation in the second time period.

12. The system of claim 11, wherein the one or more reference energy ranges include a first energy range and a second energy range in the second time period, and the determining, based on the scan data in the second time period, a plurality of energy ranges of coincidence events includes:
obtaining a minimum energy value and a maximum energy value based on a coincidence energy window for determining coincidence events of the PET scan;
determining a first energy value and a second energy value, wherein the first energy value is smaller than the energy value corresponding to the true coincidence event and the second energy value is greater than the energy value corresponding to the true coincidence event; and
determining the first energy range and the second energy range based on the minimum energy value, the maximum energy value, the first energy value, and the second energy value.

13. A system for positron emission tomography (PET) imaging, comprising:
at least one storage device including a set of instructions; and
at least one processor in communication with the at least one storage device, wherein when executing the set of instructions, the at least one processor is configured to direct the system to perform operations including:
obtaining scan data of an object of a PET scan of the object, wherein the scan data is in form of histo-image;
obtaining an attenuation map of the object; and
determining, based on the scan data and the attenuation map of the object, an activity map of a tracer for the PET scan using an activity map determination model.

14. The system of claim 13, wherein the operations further including:
performing, based on the activity map, a scatter correction on the scan data.

15. The system of claim 14, wherein the performing, based on the activity map, a scatter correction on the scan data includes:
determining, based on the attenuation map and the activity map of the tracer, a scatter estimation of the tracer; and
performing, based on the scatter estimation, the scatter correction on the scan data.

16. The system of claim 14, wherein the activity map determination mode is generated according to a training process including:
obtaining one or more training samples each of which includes sample scan data of a sample object, a sample attenuation map of the sample object, and a reference activity map of a tracer, wherein the sample scan data is in form of histo-image; and
generating the activity map determination mode by training a preliminary model using the one or more training samples.

17. A system for positron emission tomography (PET) imaging, comprising:
at least one storage device including a set of instructions; and
at least one processor in communication with the at least one storage device, wherein when executing the set of instructions, the at least one processor is configured to direct the system to perform operations including:
obtaining scan data of an object of a PET scan of the object;
determining, based on the scan data, a plurality of energy ranges of coincidence events generated in the PET scan; and
determining, based on the plurality of energy ranges of coincidence events, scatter estimation of a tracer for the PET scan.

18. The system of claim 17, wherein the operations further including:
performing, based on the scatter estimation, a scatter correction on the scan data.

19. The system of claim 17, wherein the determining, based on the plurality of energy ranges of coincidence events, scatter estimation of a tracer for the PET scan includes:
obtaining, based on the scan data, a count of coincidence events corresponding to each of one or more reference energy ranges among the plurality of energy ranges of coincidence events, wherein energy values in at least one of the one or more reference energy ranges are smaller than an energy value corresponding to a true coincidence event;
determining, based on the plurality of energy ranges and the count of coincidence events corresponding to each of the one or more reference energy ranges, the scatter estimation.

20. The system of claim 19, wherein the one or more reference energy ranges include a first energy range and a second energy range in the second time period, and the determining, based on the scan data in the second time period, a plurality of energy ranges of coincidence events includes:
obtaining a minimum energy value and a maximum energy value based on a coincidence energy window for determining coincidence events of the PET scan;
determining a first energy value and a second energy value, wherein the first energy value is smaller than the energy value corresponding to the true coincidence event and the second energy value is greater than the energy value corresponding to the true coincidence event; and
determining the first energy range and the second energy range based on the minimum energy value, the maximum energy value, the first energy value, and the second energy value.

21-29. (canceled)
